(19) United States
(12) Patent Application Publication
(10) Pub. No.: US 2024/0199923 A1
(43) Pub. Date: Jun. 20, 2024

(54) DRY ADHESIVE ARTICLE INCLUDING A LAYER OF POLYACRYLATE BLOCK COPOLYMER NANOFIBERS, A METHOD OF FORMING THE LAYER OF NANOFIBERS, AND A LIQUID COMPOSITION FOR USE IN FORMING THE LAYER OF NANOFIBERS

(71) Applicant: tea SE, Norderstedt (DE)

(72) Inventors: Thilo Dollase, Hamburg (DE); Cameron Vance Thompson, Grand Rapids, MI (US); Bernd Lühmann, Norderstedt (DE)

(73) Assignee: tesa SE, Norderstedt (DE)

(21) Appl. No.: 18/285,197

(22) PCT Filed: Mar. 16, 2022
(86) PCT No.: PCT/EP2022/056793

§ 371 Date: Sep. 29, 2023

Related U.S. Application Data
(60) Provisional application No. 63/168,219, filed on Mar. 30, 2021.

(51) Int. Cl. C09J 7/38; C09J 7/28; C09J 153/00; D01F 6/36; D04H 1/4282; D04H 1/4382; D04H 1/56; D04H 1/728

(52) U.S. Cl. CPC C09J 7/387; C09J 7/28; C09J 153/00; D01F 6/36; D04H 1/4282; D04H 1/43838; D04H 1/56; D04H 1/728; C09J 2301/122; C09J 2301/202; C09J 2301/302; C09J 2400/163; C09J 2453/00; D10B 2321/08

(57) ABSTRACT

A dry adhesive article comprising: (i) a substrate comprising a primary surface and (ii) a layer of nanofibers disposed on the primary surface of the substrate in a random orientation, the layer comprising a polyacrylate block copolymer; wherein, the layer of nanofibers exhibit pressure-sensitive adhesion.

### CROSS-REFERENCE TO RELATED APPLICATIONS

This application claims the benefit of priority under 35 U.S.C. § 371 of International Application No. PCT/EP2022/056793, filed 16 Mar. 2022, which claims the benefit of priority of U.S. Provisional Patent Application No. 63/168,219, filed 30 Mar. 2021.

### BACKGROUND

There is a general need for dry adhesive articles with greater durability to various environmental conditions. Dry adhesive articles formed of a layer of polystyrene and polydiene are useful but can suffer from thermal aging oxidation and ozone attack leading to a decline in adhesive properties and potentially adhesive strength. That problem arises in particular in dry adhesive articles with a layer of fibers because the layer is porous and, consequently, provides a high surface-to-volume ratio for oxygen to attack. Efforts to address that problem have required the use of environmentally suboptimal chlorinated solvents. As chlorinated solvents are suboptimal, there is a general desire to discover useful non-chlorinated solvents.

### SUMMARY

The present disclosure addresses those problems with a dry adhesive article that includes a layer of polyacrylate block copolymer nanofibers, that are preferably randomly oriented. The incorporation of the polyacrylate block copolymer is believed to improve the aging of the dry adhesive article. In addition, such dry adhesive articles, including the preferably randomly oriented polyacrylate block copolymer nanofibers, exhibit surprisingly high shear adhesion combined with a surprisingly low peel adhesion. The polyacrylate block copolymer nanofibers can be formed via an electrospinning process that utilizes a liquid composition that includes the polyacrylate block copolymer dissolved in one or more solvents that do not contain a chlorine moiety.

According to a first aspect of the present disclosure, a dry adhesive article comprises: (a) a substrate comprising a primary surface and (b) a layer of nanofibers disposed on the primary surface of the substrate in a random orientation, the layer comprising a polyacrylate block copolymer; wherein, the layer of the nanofibers exhibits pressure-sensitive adhesion.

According to a second aspect of the present disclosure, the dry adhesive article of the first aspect, wherein the polyacrylate block copolymer is A-B and/or A-B-A, where preferably A is poly(methyl methacrylate) and preferably B is poly(n-butyl acrylate).

According to a third aspect of the present disclosure, the dry adhesive article of any one of the first through second aspects, wherein the substrate comprises a plastic or metal, particularly aluminum foil.

In an alternative embodiment the substrate is a liner. A liner comprises a paper- or film-based backing that is equipped with an antiadhesive coating (release coating) in order to reduce the tendency of an adhesive mass to adhere to these surfaces. Crosslinkable silicone systems are often used as release coating. Among these are mixtures made of crosslinking catalysts and of what are known as heat-curable condensation- or addition-crosslinking polysiloxanes. For condensation-crosslinking silicone systems, tin compounds are often present as crosslinking catalysts in the composition, an example being dibutyltin diacetate. Liners preferably comprise backing materials with antiadhesive coating on one or both sides, examples being paper, in particular coated paper, such as PE paper, and oriented PP, HDPE, LDPE, PVC, MOPP, BOPP, PEN, PMP, PA, and/or PET films. Particular preference is given to silicone-coated liners, and also to liners which have silicone-free release layers, an example being paraffin, Teflon, or waxes. Composite materials can also be used as liners, an example being PET/aluminum foil.

According to a fourth aspect of the present disclosure, the dry adhesive article of any one of the first through third aspects, wherein (i) the substrate comprises a thickness between the primary surface and another surface of the substrate and (ii) the thickness of the substrate is within a range of from 25 μm to 130 μm.

According to a fifth aspect of the present disclosure, the dry adhesive article of any one of the first through fourth aspects, wherein (i) the layer of the nanofibers comprises a thickness perpendicular to a primary surface and (ii) the thickness of the layer of the nanofibers is within a range of from 1.5 μm to 6 μm.

According to a sixth aspect of the present disclosure, the dry adhesive article of any one of the first through fifth aspects, wherein at least a portion of the nanofibers has a diameter within a range of from 350 nm to 2000 nm.

According to a seventh aspect of the present disclosure, the dry adhesive article of any one of the first through sixth aspects, wherein the layer of nanofibers has a coat weight within a range of from 1 g/m² to 8 g/m², and the dry adhesive article exhibits a peel adhesion within a range of from 1.06 N/cm to 1.55 N/cm and a dynamic shear force within a range of from 46.0 N/cm² to 58.0 N/cm².

According to an eighth aspect of the present disclosure, the dry adhesive article of any one of the first through sixth aspects, wherein the layer of nanofibers has a coat weight within a range of from 1.2 g/m² to 12.8 g/m², and the dry adhesive article exhibits a peel adhesion within a range of from 0.39 N/cm to 1.36 N/cm and a dynamic shear force within a range of from 28.1 N/cm² to 54.5 cm².

According to a ninth aspect of the present disclosure, a method of forming a layer of nanofibers comprises: (a) applying a voltage to a liquid composition comprising a polyacrylate block copolymer dissolved in one or more solvents; (b) projecting the liquid composition toward a collector, with at least a portion of the one or more solvents evaporating before reaching the collector; and (c) depositing nanofibers comprising the polyacrylate block copolymer onto the collector, thus forming a layer of nanofibers on the collector, wherein the nanofibers are randomly oriented on the collector.

According to a tenth aspect of the present disclosure, the method of the ninth aspect is presented, wherein the one or more solvents comprises both methyl ethyl ketone and N,N-dimethylacetamide.

According to an eleventh aspect of the present disclosure, the method of the tenth aspect is presented, wherein the weight percentages of methyl ethyl ketone and N,N-dimethylacetamide both exceed 20 wt %, and the weight percentage of N,N-dimethylacetamide exceeds the weight percentage of methyl ethyl ketone.

According to a twelfth aspect of the present disclosure, the method of the ninth aspect is presented, wherein the one or more solvents are selected from the group consisting of: tert-butyl acetate, N,N dimethylacetamide; methyl ethyl ketone, n-butyl acetate, iso-butyl acetate, methyl isobutyl ketone, and ethyl acetate.

According to a thirteenth aspect of the present disclosure, the method of the ninth aspect is presented, wherein the one or more solvents comprise both tert-butyl acetate and N,N dimethylacetamide.

According to a fourteenth aspect of the present disclosure, the method of the ninth aspect is presented, wherein the one or more solvents comprise both methyl ethyl ketone and n-butyl acetate.

According to a fifteenth aspect of the present disclosure, the method of the ninth aspect is presented, wherein the one or more solvents comprise both methyl ethyl ketone and iso-butyl acetate.

According to a sixteenth aspect of the present disclosure, the method of any one of the ninth through fifteenth aspects is presented, wherein the polyacrylate block copolymer comprises at least an A polymer block and a B polymer block, where the A polymer block has a softening point above room temperature, and the B polymer block has a softening point below room temperature.

According to a seventeenth aspect of the present disclosure, the method of the sixteenth aspect is presented, wherein the A polymer block is poly(methyl methacrylate).

According to an eighteenth aspect of the present disclosure, the method of any one of the ninth through fifteenth aspects is presented, wherein the polyacrylate block copolymer is arranged A-B and/or A-B-A, where preferably A is poly(methyl methacrylate) and preferably B is poly(n-butyl acrylate).

According to a nineteenth aspect of the present disclosure, the method of the eighteenth aspect is presented, wherein a weight percentage of poly(methyl methacrylate) in the polyacrylate block copolymer is 10 wt % to 25 wt %.

According to a twentieth aspect of the present disclosure, the method of any one of the ninth through nineteenth aspects is presented, wherein the liquid composition further comprises: a tackifier resin dissolved in the one or more solvents.

According to a twenty-first aspect of the present disclosure, the method of the twentieth aspect is presented, wherein the tackifier resin comprises a terpene phenolic resin.

According to a twenty-second aspect of the present disclosure, the method of any one of the ninth through twenty-first aspects is presented, wherein the liquid composition further comprises: a salt.

According to a twenty-third aspect of the present disclosure, the method of the twenty-second aspect is presented, wherein the salt comprises pyridinium formate.

According to a twenty-fourth aspect of the present disclosure, the method of the twenty-second aspect is presented, wherein the salt is less than or equal to 0.5 wt % of the liquid composition.

According to a twenty-fifth aspect of the present disclosure, the method of any one of the ninth through twenty-fourth aspects is presented, wherein the liquid composition comprises: 20 wt % to 40 wt % of the polyacrylate block copolymer and 50 wt % to 70 wt % of the one or more solvents.

According to a twenty-sixth aspect of the present disclosure, the method of the twenty-fifth aspect is presented, wherein the liquid composition further comprises 5 wt % to 15 wt % of a tackifier resin.

According to a twenty-seventh aspect of the present disclosure, the method of any one of the ninth through twenty-sixth aspects is presented, wherein the one or more solvents are substantially free of a solvent with a chlorine moiety.

According to a twenty-eighth aspect of the present disclosure, a liquid composition for electrospinning a layer of nanofibers comprises: a polyacrylate block copolymer dissolved in one or more solvents.

According to a twenty-ninth aspect of the present disclosure, the liquid composition of the twenty-eighth aspect is presented, wherein the one or more solvents comprise both methyl ethyl ketone and N,N-dimethylacetamide.

According to a thirtieth aspect of the present disclosure, the liquid composition of the twenty-ninth aspect is presented, wherein weight percentages of methyl ethyl ketone and N,N-dimethylacetamide both exceed 20 wt %, and the weight percentage of N,N-dimethylacetamide exceeds the weight percentage of methyl ethyl ketone.

According to a thirty-first aspect of the present disclosure, the liquid composition of the twenty-eighth aspect is presented, wherein the one or more solvents are selected from the group consisting of: tert-butyl acetate, N,N dimethylacetamide; methyl ethyl ketone, n-butyl acetate, iso-butyl acetate, methyl isobutyl ketone, and ethyl acetate.

According to a thirty-second aspect of the present disclosure, the liquid composition of the twenty-eighth aspect is presented, wherein the one or more solvents comprise both tert-butyl acetate and N,N dimethylacetamide.

According to a thirty-third aspect of the present disclosure, the liquid composition of the twenty-eighth aspect is presented, wherein the one or more solvents comprise both methyl ethyl ketone and n-butyl acetate.

According to a thirty-fourth aspect of the present disclosure, the liquid composition of the twenty-eighth aspect is presented, wherein the one or more solvents comprise both methyl ethyl ketone and iso-butyl acetate.

According to a thirty-fifth aspect of the present disclosure, the liquid composition of any one of the twenty-eighth through thirty-fourth aspects is presented, wherein the polyacrylate block copolymer comprises at least an A polymer block and a B polymer block, where the A polymer block has a softening point above room temperature, and the B polymer block has a softening point below room temperature.

According to a thirty-sixth aspect of the present disclosure, the liquid composition of the thirty-fifth aspect is presented, wherein the A polymer block is poly(methyl methacrylate).

According to a thirty-seventh aspect of the present disclosure, the liquid composition of any one of the twenty-eighth through thirty-fourth aspects is presented, wherein the polyacrylate block copolymer is arranged A-B and/or A-B-A, where preferably A is poly(methyl methacrylate) and preferably B is poly(n-butyl acrylate).

According to a thirty-eighth aspect of the present disclosure, the liquid composition of the thirty-seventh aspect is presented, wherein a weight percentage of poly(methyl methacrylate) in the polyacrylate block copolymer is 10 wt % to 25 wt %.

According to a thirty-ninth aspect of the present disclosure, the liquid composition of any one of the twenty-eighth through thirty-seventh aspects further comprises a tackifier resin dissolved in the one or more solvents.

According to a fortieth aspect of the present disclosure, the liquid composition of the thirty-ninth aspect is presented, wherein the tackifier resin comprises a terpene phenolic resin.

According to a forty-first aspect of the present disclosure, the liquid composition of any one of the twenty-eighth through fortieth aspects further comprises a salt.

According to a forty-second aspect of the present disclosure, the liquid composition of the forty-first aspect is presented, wherein the salt comprises pyridinium formate.

According to a forty-third aspect of the present disclosure, the liquid composition of the forty-first aspect is presented, wherein the salt is less than or equal to 0.5 wt % of the liquid composition.

According to a forty-fourth aspect of the present disclosure, the liquid composition of the twenty-eighth aspect is presented, wherein the liquid composition comprises: 20 wt % to 40 wt % of the polyacrylate block copolymer and 50 wt % to 70 wt % of the one or more solvents.

According to a forty-fifth aspect of the present disclosure, the liquid composition of the forty-fourth aspect is presented, wherein the liquid composition further comprises 5 wt % to 15 wt % of a tackifier resin.

According to a forty-sixth aspect of the present disclosure, the liquid composition of any one of the twenty-eighth through forty-fifth aspects is presented, wherein the one or more solvents are substantially free of a solvent with a chlorine moiety.

### BRIEF DESCRIPTION OF THE DRAWINGS

In the Drawings:

FIG. 1 is a perspective view of an electrospinning apparatus via which a layer of nanofibers of the present disclosure, in a random orientation, is formed;

FIG. 2 is a cross-sectional view of a dry adhesive article include the layer of nanofibers of FIG. 1 disposed on a substrate, illustrating both the layer and the substrate having a thickness;

FIG. 3 is a scanning electron microscope image of a layer of nanofibers arranged in random orientation

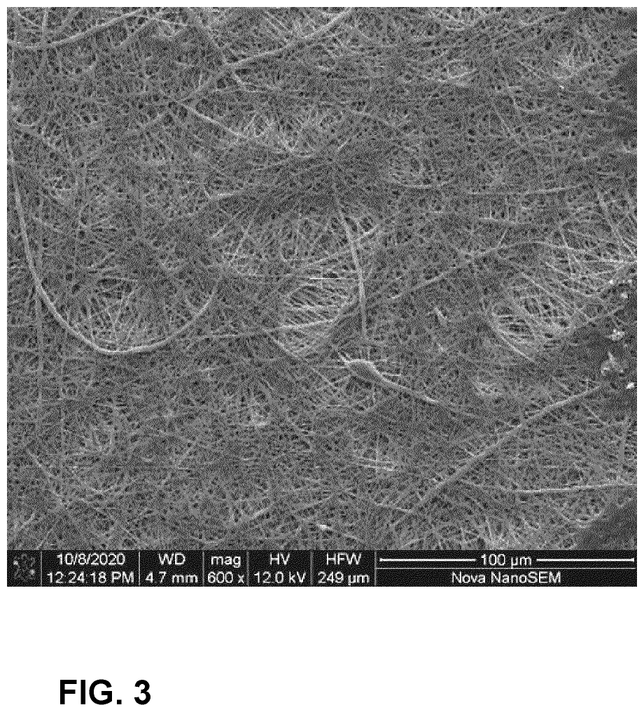

### DETAILED DESCRIPTION

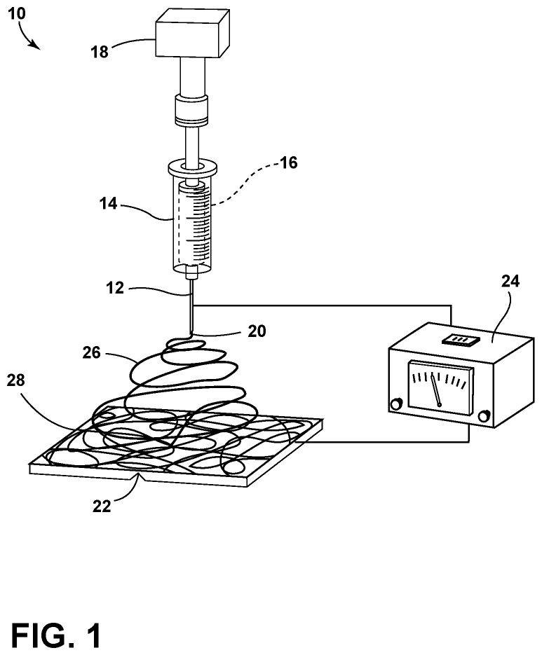

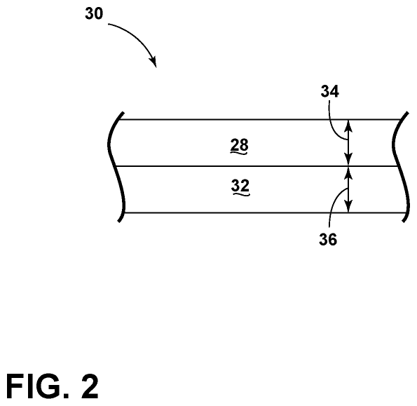

Referring now to FIGS. 1 and 2, a dry adhesive article 30 of the present disclosure is illustrated. The dry adhesive article 30 includes a substrate 32, which includes a primary surface, and a layer 28 of nanofibers 26 disposed on the primary surface of the substrate 32. The nanofibers 26 include a polyacrylate block copolymer. The phrase “polyacrylate block copolymer” as used herein includes a single polyacrylate block copolymer and more than one polyacrylate block copolymers. In other words, the nanofibers 26 include one or more polyacrylate block copolymers.

The nanofibers 26 forming the layer 28 have a random orientation, as is illustrated for example at FIG. 1. The nanofibers 26 are randomly oriented in the x-y plane (e.g., the plane that the primary surface of the substrate 32 forms), and, in embodiments, also in the z-direction (along a thickness 34 of the layer 28 that is perpendicular to the primary surface of the substrate 32). In embodiments, the thickness 34 of the layer 28 of nanofibers 26 is 1 μm, 1.5 μm, 2 μm, 2.5 μm, 3 μm, 3.5 μm, 4 μm, 4.5 μm, 5 μm, 5.5 μm, or 6 μm, or within any range bound by any two of those values (e.g., from 1 μm to 7 μm, from 1.5 μm to 6 μm, and so on). In embodiments, at least a portion of the nanofibers 26 has a diameter of 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, 1550 nm, 1600 nm, 1650 nm, 1700 nm, 1750 nm, 1800 nm, 1850 nm, 1900 nm, 1950 nm, or 2000 nm, or within any range bound by any two of those values (e.g., from 350 nm to 2000 nm, from 500 nm to 1500 nm, and so on).

In embodiments, the polyacrylate block copolymers is A-B and/or A-B-A, where A is preferably poly(methyl methacrylate) and B is preferably poly(n-butyl acrylate). It is believed the presence of polyacrylate block copolymer in the nanofibers 26 imparts the layer 28 and thus the dry adhesive article 30 with improved stability against ultraviolet degradation and oxidation (aging). In embodiments, the polyacrylate block copolymer includes at least an A polymer block and a B polymer block, where the A polymer block has a softening point above room temperature, and the B polymer block has a softening point below room temperature. In embodiments, the A polymer block with a softening point above room temperature generally can be a homopolymer or copolymer comprising methacrylate(s) and/or acrylate(s). In embodiments, the B polymer block with a softening point below room temperature generally can be a homopolymer or copolymer comprising methacrylate(s) and/or acrylate(s). In embodiments, a weight percentage of A block(s) in the polyacrylate block copolymer is 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, or 35 wt %, or within any range bound by any two of those values (e.g., from 10 wt % to 25 wt %, from 10 wt % to 35 wt %, from 15 wt % to 20 wt %, and so on). Beneficial poly(methyl methacrylate)/poly(n-butyl acrylate)/poly(methyl methacrylate) polyacrylate tri-block copolymers are commercially available from Kuraray America Inc. as product codes LA2140, LA2330, LA2250, and LA3220.

In embodiments, the nanofibers 26 further include one or more of a tackifier, a plasticizer, a stabilizer, and an additional polymer or polymers. In embodiments, the tackifier is a thermoplastic terpene phenolic resin (e.g., Sylvares 1105 from Kraton Corporation). In embodiments, the tackifier is a rosin ester (e.g., Pinecrystal KE-311 from Arakawa Chemical). In embodiments, the tackifier is a hydrocarbon resin (e.g., Kristalex F85 and Regalrez 3102 from Eastman Corporation). In embodiments, the tackifier is a low molecular weight poly(meth)acrylate. The tackifier can be a hydrogenated ester resin. The tackifier facilities adhesion of the nanofibers 26 to the substrate 32 and provides an initial “tackiness” when applying the article 30 with the layer 28 of nanofibers 26 to a surface to which the article 30 will adhere.

The substrate 32 includes a thickness 36. The thickness 36 extends between the primary surface of the substrate 32 and another primary surface of the substrate 32. The primary surfaces can be parallel to each other. In embodiments, the thickness 36 of the substrate 32 is 25 μm, 30 μm, 35 μm, 40 μm, 45 μm, 50 μm, 55 μm, 60 μm, 65 μm, 70 μm, 75 μm, 80 μm, 90 μm, 95 μm, 100 μm, 105 μm, 110 μm, 115 μm, 120 μm, 125 μm, or 130 μm, or within any range bound by any two of those values (e.g., from 25 μm to 130 μm, from 55 μm to 95 μm, and so on). In embodiments, the substrate 32 includes aluminum foil.

The layer 28 of the nanofibers 26 exhibit pressure-sensitive adhesion. It has been surprisingly discovered that the dry adhesive article 30 described herein, with the randomly oriented deposited nanofibers 26, provides beneficial dry adhesive properties. As the data from the Examples below illustrates, the dry adhesive article 30 with the layer 28 of nanofibers 26 with the polyacrylate block copolymer exhibits removability (relatively low peel adhesion values). Upon removal, the dry adhesive article 30 leaves no residue on the surface to which the dry adhesive article 30 was adhered.

In embodiments, the layer 28 of nanofibers 26 has a coat weight of 1.0 g/m², 1.2 g/m², 2.0 g/m², 3.0 g/m², 4.0 g/m², 5.0 g/m², 6.0 g/m², 7.0 g/m², 8.0 g/m², 9.0 g/m², 10.0 g/m², 11.0 g/m², 12.0 g/m², 12.8 g/m², 13.0 g/m², 14.0 g/m², or 15.0 g/m², or within any range bound by any two of those values (e.g., from 1.2 g/m² to 12.8 g/m², from 3.0 g/m² to 8.0 g/m², from 1.0 g/m² to 15.0 g/m², from 2.0 g/m² to 12.0 g/m², from 1.0 g/m² to 8.0 g/m², and so on).

In embodiments, the dry adhesive article 30 exhibits a peel adhesion of 0.39 N/cm, 0.5 N/cm, 0.6 N/cm, 0.7 N/cm, 0.8 N/cm, 0.9 N/cm, 1.0 N/cm, 1.06 N/cm, 1.10 N/cm, 1.20 N/cm, 1.30 N/cm, 1.36 N/cm, 1.40 N/cm, 1.5 N/cm, or 1.55 N/cm, or within any range bound by any two of those values (e.g., from 0.39 N/cm to 1.36 N/cm, from 0.6 N/cm to 0.7 N/cm, from 1.06 N/cm to 1.55 N/cm, from 1.10 N/cm to 1.30 N/cm, and so on). To test peel adhesion, the layer 28 is laminated onto a substrate 32 of aluminum foil having a thickness 36 of 25 μm. The article 30 of the layer 28 on the substrate 32 is then pressurized to polypropylene and sandpaper plates. The low peel adhesion values that the dry adhesive article 30 exhibit demonstrate reusability.

In embodiments, the dry adhesive article 30 exhibits a dynamic shear force of 28.1 N/cm², 30.0 N/cm², 32.0 N/cm², 34.0 N/cm², 36.0 N/cm², 38.0 N/cm², 40.0 N/cm², 42.0 N/cm², 44.0 N/cm², 46.0 N/cm², 47.0 N/cm², 48.0 N/cm², 49.0 N/cm², 50.0 N/cm², 51 N/cm², 52.0 N/cm², 53.0 N/cm², 54.0 N/cm², 54.5 cm², 55.0 N/cm², 56.0 N/cm², 57.0 N/cm², or 58.0 N/cm², or within any range bound by any two of those values (e.g., from 28.1 N/cm² to 54.5 cm², from 32.0 N/cm² to 48.0 N/cm², from 46.0 N/cm² to 58.0 N/cm², from 49.0 N/cm² to 55.0 N/cm², and so on). These dynamic shear values are higher than styrene block copolymer (e.g., SBS) based adhesives with similar peel adhesion values. The results are surprising because poly(acrylate) based pressure sensitive adhesive films (i.e., not a layer 28 of nanofibers 26 that are randomly oriented) generally demonstrate high peel adhesion combined with low dynamic shear adhesion for the same coat weight. To test dynamic shear adhesion, the layer 28 is laminated to a substrate 32 of aluminum foil having a thickness 36 of 130 μm. The article 30 with the layer 28 on the substrate 32 is then pressurized to a stainless steel plate with a total area of 16 mm×19 mm.

The layer 28 takes the form of a mat that is generally porous because the nanofibers 26 are randomly oriented. The article 30 has potential applications as a debonding-on-demand tape, as a thin sticky non-woven adhesive layer for viscoelastic core structural bonding tapes, as an air permeable non-woven adhesive layer for venting tapes, (with the addition of electrically conductive additives, such as graphene, carbon nanotubes, etc.), as an electrically conductive thin sticky non-woven adhesive layer, and as non-woven nanofiber layers for thermal management (e.g., isolation in electronics).

Referring now to FIG. 1, a method of forming the layer 28 of the nanofibers 26 is herein described. At a step, the method includes applying a voltage to a liquid composition 16 comprising the polyacrylate block copolymer dissolved in one or more solvents. For example, an electrospinning apparatus 10 can be utilized. The electrospinning apparatus 30 includes a needle 12. The needle 12 is in liquid communication with a pipette 14. The pipette 14 contains the liquid composition 16. A syringe pump 18 controls flow of the liquid composition 16 through an outlet 20 of the needle 12. A collector 22 is disposed below the outlet 20 of the needle 12. A high-voltage power supply 24 applies the voltage to the liquid composition 16 at the outlet 20 of the needle 12.

At another step, the method further includes projecting the liquid composition 16 toward the collector 22, with at least a portion of the one or more solvents evaporating before reaching the collector 22. For example, as the voltage is applied to the liquid composition 16, the liquid composition 16 becomes charged and electrostatic repulsion stretches the liquid composition 16, causing the liquid composition 16 to form a Taylor cone. The liquid composition 16 projects as the Taylor cone toward the collector 22. Before the liquid composition 16 reaches the collector 22, at least a portion of the one or more solvents evaporates.

At another step, the method includes depositing the nanofibers 26 of the polyacrylate block copolymer onto the collector 22, thus forming the layer 28 of the nanofibers 26 on the collector 22. For example, as the one or more solvents evaporate from the liquid composition 16 on route to the collector 22, the polyacrylate block copolymer, previously dissolved in the one or more solvents, precipitates and solidifies as the nanofibers 26 on the collector 22. The process is continued and the nanofibers 26 collect, in random orientation, to form the layer 28. In embodiments, the collector 22 is a siliconized double sided release paper (available e.g. from Loparex). The layer 28 of the nanofibers 26 can then be transferred from the collector 22 to the primary surface of the substrate 32.

The layer 28 with the nanofibers 26 in random orientation is significantly easier and faster to manufacture than nanofibers 26 that are substantially aligned (e.g., in the x-y plane). Substantially aligning the nanofibers 26 on the collector 22 (e.g., nanofibers 26 aligned lengthwise next to each other on the collector 22) includes more difficult processing steps, which can include moving the collector 22 (e.g., rotating a cylindrical form of the collector) as the liquid composition 16 is ejected from the outlet 20 of the needle 12.

The electrospinning process can beneficially be carried out in a needleless apparatus. A specific example of needleless electrospinning equipment is the Nanospider™ which is commercially available from Elmarco s.r.o. This system employs a wire electrode oriented in cross direction with respect to the web and which ejects several jets.

In embodiments, the one or more solvents of the liquid composition 28 are chosen so that polyacrylate block copolymer dissolves within the one or more solvents, which allows the nanofibers 26 to be formed via electrospinning. In addition, the one or more solvents are suitably electrically conductive to allow for electrospinning. In embodiments, the liquid composition includes (i) from 20 wt % to 40 wt % of the polyacrylate block copolymer and (ii) from 50 wt % to 70 wt % of the one or more solvents.

In embodiments, the one or more solvents include methyl ethyl ketone. In embodiments, the one or more solvents include N,N-dimethylacetamide. In embodiments, the one or more solvents include both methyl ethyl ketone and N,N-dimethylacetamide. In embodiments, the one or more solvents include both methyl ethyl ketone and N,N-dimethylacetamide, where the weight percentages of methyl ethyl ketone and N,N-dimethylacetamide both exceed 20 wt %, and the weight percentage of N,N-dimethylacetamide exceeds the weight percentage of methyl ethyl ketone.

In embodiments, the one or more solvents include one or more of (e.g., are chosen from the group consisting of) tert-butyl acetate, n-butyl acetate, iso-butyl acetate, methyl isobutyl ketone, and ethyl acetate. In embodiments, the one or more solvents include both tert-butyl acetate and N,N dimethylacetamide (e.g., 70 wt % tert-butyl acetate and 30% N,N dimethylacetamide, with the total equaling 100 wt % of the one or more solvents). In embodiments, the one or more solvents include both methyl ethyl ketone and n-butyl acetate (e.g., 65 wt % methyl ethyl ketone, 35 wt % n-butyl acetate, with the total equaling 100 wt % of the one or more solvents). In embodiments, the one or more solvents include both methyl ethyl ketone and iso-butyl acetate (e.g., 60% methyl ethyl ketone, 40% iso-butyl acetate, with the total equaling 100 wt % of the one or more solvents).

In embodiments, the one or more solvents include an ester. In embodiments, the one or more solvents include an ester and are substantially free of N,N dimethylacetamide. In embodiments, the one or more solvents are substantially free of any solvent that includes a chlorine moiety (e.g., the one or more solvents do not contain a chlorine moiety).

In embodiments, the one or more solvents are substantially free of any solvent that includes a nitrogen moiety (e.g., the one or more solvents do not contain a nitrogen moiety).

However, it should be understood that the one or more solvents of the liquid composition 16, within which the polyacrylate block copolymer is dissolved, can include a halogenated (e.g., chlorinated) or nitrogen-containing solvent. In other words, in embodiments, the dry adhesive article 30 of the present disclosure that includes the layer 28 of the nanofibers 26 that include the polyacrylate block copolymer is formed from a liquid composition 16 that includes a halogenated solvent.

As mentioned, the nanofibers 26 can further include the tackifier and, thus, in embodiments, the liquid composition 16 further includes the tackifier dissolved in the one or more solvents. In embodiments, the tackifier is 0 wt %, 5 wt %, 10 wt %, 15 wt %, 20 wt %, 25 wt %, 30 wt %, 35 wt %, or 40 wt % of the liquid composition 16, or within any range bound by any two of those values (e.g., from 0 wt % to 40 wt % of the liquid composition 16, from 0 wt % to 30 wt %, from 5 wt % to 35 wt %, from 5 wt % to 15 wt %, and so on).

In embodiments, the liquid composition 16 further includes one or more a plasticizer, a stabilizer, further polymers, and additives (such as a salt). The layer 28 of nanofibers 26 includes the polyacrylate block copolymer that was originally dissolved in the liquid composition 16, as well as any of the one or more of a tackifier, a plasticizer, and a stabilizer included in the liquid composition 16. The salt can adjust the conductivity of the liquid composition 16, which helps control jet formation during the electrospinning. In embodiments, the salt includes pyridinium formate. In embodiments, the salt is less than or equal to 0.5 wt % of the liquid composition 16.

In embodiments, each nanofiber 26 comprises the polyacrylate block copolymer that was originally dissolved in the liquid composition 16, as well as any of the one or more of a tackifier, a plasticizer, and a stabilizer included in the liquid composition 16.

In embodiments, when the single needle 12 electrospinning apparatus 10 is utilized, the liquid composition 16 has a viscosity in a range of from 0.3 Pas to 0.5 Pa·s. In embodiments, the flow rate of the liquid composition 16 is within a range of from 2 mL/hr to 4 mL/hr. In embodiments, the volume of the liquid composition 16 is within a range of from 0.5 mL to 3 mL. In embodiments, the voltage applied is within a range of from 19 kV to 27 kV. In embodiments, the distance between the outlet 20 of the needle 12 and the collector 22 is within a range of from 12 cm to 16 cm.

Although the electrospinning apparatus 10 described above includes only the needle 12, multiple nozzles or nozzle-less apparatuses could be used to form the layer 28 of nanofibers 26 via electrospinning. If multiple nozzles are utilized, the same general parameters apply. If the nozzle-less, wire-based, apparatus is utilized, the voltage can be within a range of from 60 kV to 100 kV, the substrate speed can be within a range of from 30 mm/min to 100 mm/min, the spinning distance can be within a range of from 220 mm to 240 mm, and the carriage speed can be within a range of from 60 mm/min to 240 mm/min.

Examples—Several examples are detailed below. For each example, Sylvares 1105 (Kraton Corporation) is a terpene phenolic resin, included as a tackifier. LA3320 (Kuraray America Inc.) is a polyacrylate block copolymer and is A-B-A, where A is poly(methyl methacrylate) and B is poly(n-butyl acrylate), with about 15 wt % poly(methyl methacrylate). All components of the composition were added to a single vessel, the vessel closed, and the components stirred overnight at standard ambient temperature and pressure to ensure total dissolution of the resin and polyacrylate block copolymer into the solvents (methyl ethyl ketone and N,N-dimethylacetamide). The composition was then spun through a single-needle electrospinning apparatus as a layer of polymeric nanofibers onto a relief liner, in three different attempts for each example composition, each attempt having a different volume and different spinning conditions as stated. The layer of polymeric nanofibers was then transferred to an aluminum foil for testing.

Example 1—For Example 1, a composition was prepared including:
25 wt % LA3320;
10 wt % Sylvares 1105;
26 wt % methyl ethyl ketone; and
39 wt % N,N-dimethylacetamide.

The voltage applied was 19 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 1 below.

TABLE 1
(Example 1)

| | | Coat | | Peel, | | Shear, | |
|---|---|---|---|---|---|---|---|
| | Volume | Weight | Standard | Fiber | Standard | Fiber | Standard |
| Attempt | (mL) | (g/m²) | Deviation | (N/cm) | Deviation | (N/cm²) | Deviation |
| 1 | 0.7 | 3.769 | 0.000 | 0.506 | 0.065 | 28.121 | 12.211 |
| 2 | 1.05 | 5.849 | 0.569 | 0.832 | 0.040 | 43.045 | 1.402 |
| 3 | 1.4 | 8.996 | 0.644 | 1.069 | 0.062 | 41.563 | 1.569 |

Example 2—For Example 2, a composition was prepared including:
35 wt % LA3320;
10 wt % Sylvares 1105;
22 wt % methyl ethyl ketone; and
33 wt % N,N-dimethylacetamide.

The voltage applied was 19 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 2 below.

TABLE 2
(Example 2)

| | | Coat | | Peel, | | Shear, | |
|---|---|---|---|---|---|---|---|
| | Volume | Weight | Standard | Fiber | Standard | Fiber | Standard |
| Attempt | (mL) | (g/m²) | Deviation | (N/cm) | Deviation | (N/cm²) | Deviation |
| 1 | 0.55 | 5.529 | 1.037 | 1.476 | 0.529 | 41.420 | 4.467 |
| 2 | 0.825 | 10.116 | 0.528 | 1.636 | 0.223 | 51.571 | 1.625 |
| 3 | 1.1 | 12.782 | 0.870 | 1.413 | 0.103 | 54.455 | 1.117 |

Example 3—For Example 3, a composition was prepared including:
25 wt % LA3320;
10 wt % Sylvares 1105;
26 wt % methyl ethyl ketone; and
39 wt % N,N-dimethylacetamide.

The voltage applied was 19 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 3 below.

TABLE 3
(Example 3)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.7 | 3.502 | 0.151 | 0.936 | 0.046 | 43.679 | 2.409 |
| 2 | 1.05 | 7.129 | 0.131 | 1.243 | 0.092 | 49.214 | 1.105 |
| 3 | 1.4 | 6.596 | 0.075 | 1.163 | 0.065 | 47.398 | 0.417 |

Example 4—For Example 4, a composition was prepared including:
35 wt % LA3320;
10 wt % Sylvares 1105;
22 wt % methyl ethyl ketone; and
33 wt % N,N-dimethylacetamide.

The voltage applied was 19 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 4 below.

TABLE 4
(Example 4)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.55 | 5.209 | 1.413 | 0.958 | 0.119 | 32.053 | 4.078 |
| 2 | 0.825 | 7.502 | 0.302 | 1.089 | 0.017 | 44.185 | 0.425 |
| 3 | 1.1 | 8.996 | 0.644 | 0.969 | 0.017 | 44.740 | 0.589 |

Example 5—For Example 5, a composition was prepared including:
25 wt % LA3320;
10 wt % Sylvares 1105;
26 wt % methyl ethyl ketone; and
39 wt % N,N-dimethylacetamide.

The composition further included an additional 0.1 wt % of pyridinium formate. The voltage applied was 19 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 5 below.

TABLE 5
(Example 5)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.7 | 1.209 | 0.000 | 0.526 | 0.058 | 41.988 | 0.939 |
| 2 | 1.05 | 2.489 | 0.346 | 0.632 | 0.122 | 46.403 | 0.902 |
| 3 | 1.4 | 2.276 | 0.399 | 0.737 | 0.120 | 46.828 | 1.895 |

Example 6—For Example 6, a composition was prepared including:
35 wt % LA3320;
10 wt % Sylvares 1105;
22 wt % methyl ethyl ketone; and
33 wt % N,N-dimethylacetamide.

The composition further included an additional 0.1 wt % of pyridinium formate. The voltage applied was 19 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 6 below.

TABLE 6
(Example 6)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.55 | 2.222 | 0.151 | 0.619 | 0.131 | 43.069 | 1.616 |
| 2 | 0.825 | 2.809 | 0.131 | 0.700 | 0.091 | 43.629 | 1.582 |
| 3 | 1.1 | 4.569 | 0.131 | 0.602 | 0.030 | 44.780 | 1.278 |

Example 7—For Example 7, a composition was prepared including:
25 wt % LA3320;
10 wt % Sylvares 1105;
26 wt % methyl ethyl ketone; and
39 wt % N,N-dimethylacetamide.

The composition further included an additional 0.1 wt % of pyridinium formate. The voltage applied was 19 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear.

The measured values, and the standard deviations for each measured value, are included in Table 7 below.

TABLE 7
(Example 7)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.7 | 1.742 | 0.075 | 0.394 | 0.050 | 39.641 | 1.871 |
| 2 | 1.05 | 2.436 | 0.151 | 0.698 | 0.103 | 41.187 | 1.331 |
| 3 | 1.4 | 2.329 | 0.131 | 0.865 | 0.010 | 42.097 | 1.932 |

Example 8—For Example 8, a composition was prepared including:
35 wt % LA3320;
10 wt % Sylvares 1105;
22 wt % methyl ethyl ketone; and
33 wt % N,N-dimethylacetamide.

The composition further included an additional 0.1 wt % of pyridinium formate. The voltage applied was 19 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 8 below.

TABLE 8
(Example 8)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.55 | 2.702 | 0.075 | 0.781 | 0.168 | 38.602 | 1.825 |
| 2 | 0.825 | 4.622 | 0.420 | 1.252 | 0.197 | 42.870 | 2.130 |
| 3 | 1.1 | 5.689 | 0.131 | 0.829 | 0.205 | 41.533 | 2.502 |

Example 9—For Example 9, a composition was prepared including:
25 wt % LA3320;
10 wt % Sylvares 1105;
26 wt % methyl ethyl ketone; and
39 wt % N,N-dimethylacetamide.

The voltage applied was 21 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 9 below.

TABLE 9
(Example 9)

| | | | Stan- | | | | Stan- |
|---|---|---|---|---|---|---|---|
| | | Coat | dard | Peel, | | Shear, | dard |
| | Volume | Weight | Devi- | Fiber | Standard | Fiber | Devi- |
| Attempt | (mL) | (g/m²) | ation | (N/cm) | Deviation | (N/cm²) | ation |
| 1 | 0.7 | 2.329 | 0.261 | 0.516 | 0.053 | 39.227 | 2.879 |
| 2 | 1.05 | 3.609 | 0.261 | 0.706 | 0.033 | 43.867 | 1.283 |
| 3 | 1.4 | 4.516 | 0.200 | 0.834 | 0.118 | 45.478 | 1.119 |

Example 10—For Example 10, a composition was prepared including:
35 wt % LA3320;
10 wt % Sylvares 1105;
22 wt % methyl ethyl ketone; and
33 wt % N,N-dimethylacetamide.

The voltage applied was 21 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 10 below.

TABLE 10
(Example 10)

| | | | Stan- | | | | Stan- |
|---|---|---|---|---|---|---|---|
| | | Coat | dard | Peel, | | Shear, | dard |
| | Volume | Weight | Devi- | Fiber | Standard | Fiber | Devi- |
| Attempt | (mL) | (g/m²) | ation | (N/cm) | Deviation | (N/cm²) | ation |
| 1 | 0.55 | 2.969 | 0.261 | 0.960 | 0.138 | 42.022 | 2.579 |
| 2 | 0.825 | 5.209 | 0.569 | 0.991 | 0.171 | 43.242 | 3.243 |
| 3 | 1.1 | 5.582 | 0.528 | 1.359 | 0.520 | 43.859 | 1.847 |

Example 11—For Example 11, a composition was prepared including:
25 wt % LA3320;
10 wt % Sylvares 1105;
26 wt % methyl ethyl ketone; and
39 wt % N,N-dimethylacetamide.

The voltage applied was 21 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 11 below.

TABLE 11
(Example 11)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.7 | 2.009 | 0.453 | 0.516 | 0.028 | 33.294 | 4.553 |
| 2 | 1.05 | 3.716 | 0.302 | 0.644 | 0.049 | 42.041 | 1.572 |
| 3 | 1.4 | 3.982 | 0.272 | 0.807 | 0.074 | 47.115 | 2.778 |

Example 12—For Example 12, a composition was prepared including:
35 wt % LA3320;
10 wt % Sylvares 1105;
22 wt % methyl ethyl ketone; and
33 wt % N,N-dimethylacetamide.

The voltage applied was 21 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 11 below.

TABLE 11
(Example 11)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.55 | 3.662 | 0.151 | 0.833 | 0.119 | 37.311 | 6.200 |
| 2 | 0.825 | 5.209 | 0.569 | 0.953 | 0.344 | 43.710 | 1.786 |
| 3 | 1.1 | 6.649 | 0.226 | 0.968 | 0.085 | 43.742 | 1.927 |

Example 13—For Example 13, a composition was prepared including:
25 wt % LA3320;
10 wt % Sylvares 1105;
26 wt % methyl ethyl ketone; and
39 wt % N,N-dimethylacetamide.

The composition further included an additional 0.1 wt % of pyridinium formate. The voltage applied was 21 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 13 below.

TABLE 13
(Example 13)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.7 | 2.329 | 0.131 | 0.398 | 0.067 | 47.039 | 1.435 |
| 2 | 1.05 | 3.289 | 0.131 | 0.527 | 0.092 | 45.924 | 1.622 |
| 3 | 1.4 | 5.636 | 0.272 | 1.008 | 0.036 | 48.495 | 1.250 |

Example 14—For Example 14, a composition was prepared including:
35 wt % LA3320;
10 wt % Sylvares 1105;
22 wt % methyl ethyl ketone; and
33 wt % N,N-dimethylacetamide.

The composition further included an additional 0.1 wt % of pyridinium formate. The voltage applied was 21 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 14 below.

TABLE 14
(Example 14)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.55 | 4.516 | 0.459 | 0.785 | 0.054 | 46.413 | 1.604 |
| 2 | 0.825 | 6.062 | 0.075 | 0.855 | 0.136 | 47.019 | 2.763 |
| 3 | 1.1 | 8.836 | 0.658 | 0.951 | 0.120 | 48.342 | 1.880 |

Example 15—For Example 15, a composition was prepared including:
25 wt % LA3320;
10 wt % Sylvares 1105;
26 wt % methyl ethyl ketone; and
39 wt % N,N-dimethylacetamide.

The composition further included an additional 0.1 wt % of pyridinium formate. The voltage applied was 21 kV. The distance from needle to ground electrode was 19 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 15 below.

TABLE 15
(Example 15)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.7 | 2.382 | 0.200 | 0.671 | 0.076 | 41.761 | 2.568 |
| 2 | 1.05 | 3.236 | 0.658 | 0.903 | 0.048 | 43.103 | 2.148 |
| 3 | 1.4 | 5.422 | 0.302 | 1.081 | 0.048 | 48.821 | 1.481 |

Example 16—For Example 16, a composition was prepared including:
35 wt % LA3320;
10 wt % Sylvares 1105;
22 wt % methyl ethyl ketone; and
33 wt % N,N-dimethylacetamide.

The composition further included an additional 0.1 wt % of pyridinium formate. The voltage applied was 21 kV. The distance from needle to ground electrode was 21 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 16 below.

TABLE 16
(Example 16)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.55 | 3.182 | 0.495 | 0.562 | 0.064 | 40.801 | 1.671 |
| 2 | 0.825 | 4.676 | 0.200 | 0.767 | 0.171 | 43.081 | 0.907 |
| 3 | 1.1 | 5.849 | 0.131 | 0.638 | 0.002 | 45.243 | 0.934 |

Example 17—For Example 17, a composition was prepared including:
30 wt % LA3320;
10 wt % Sylvares 1105;
24 wt % methyl ethyl ketone; and
36 wt % N,N-dimethylacetamide.

The composition further included an additional 0.1 wt % of pyridinium formate. The voltage applied was 20 kV. The distance from needle to ground electrode was 20 cm. The flow rate was 2.25 mL/hr. Each attempt produced a layer of polymeric nanofibers with adhesive properties. The coat weight for the layer of polymeric nanofibers resulting from each attempt was then measured, as were the peel adhesion and dynamic shear. The measured values, and the standard deviations for each measured value, are included in Table 17 below.

TABLE 17
(Example 17)

| | | | Stan- | | Stan- | | Stan- |
|---|---|---|---|---|---|---|---|
| | | Coat | dard | Peel, | dard | Shear, | dard |
| | Volume | Weight | Devi- | Fiber | Devi- | Fiber | Devi- |
| Attempt | (mL) | (g/m²) | ation | (N/cm) | ation | (N/cm²) | ation |
| 1 | 0.62 | 3.769 | 0.346 | 0.778 | 0.209 | 42.833 | 2.422 |
| 2 | 0.93 | 4.516 | 0.850 | 0.766 | 0.188 | 47.476 | 0.745 |
| 3 | 1.24 | 7.236 | 0.495 | 1.092 | 0.340 | 47.993 | 1.892 |

1. A dry adhesive article comprising:
a substrate comprising a primary surface; and
a layer of nanofibers disposed on the primary surface of the substrate in a preferably random orientation, the nanofibers comprising a polyacrylate block copolymer;
wherein, the layer of the nanofibers exhibits pressure-sensitive adhesion.

2. The dry adhesive article of claim 1, wherein
the polyacrylate block copolymer is A-B and/or A-B-A, where preferably A is poly(methyl methacrylate) and preferably B is poly(n-butyl acrylate).

3. The dry adhesive article of claim 1, wherein
the substrate comprises aluminum foil.

4. The dry adhesive article of claim 1, wherein
the substrate comprises a thickness between the primary surface and another primary surface of the substrate; and
the thickness of the substrate is within a range of from 25 μm to 130 μm.

5. The dry adhesive article of claim 1, wherein
the layer of the nanofibers comprises a thickness perpendicular to the primary surface of the substrate; and
the thickness of the layer of the nanofibers is within a range of from 1.5 μm to 6 μm.

6. The dry adhesive article of claim 1, wherein
at least a portion of the nanofibers has a diameter within a range of from 350 nm to 2000 nm.

7. The dry adhesive article of claim 1, wherein
the layer of nanofibers has a coat weight within a range of from 1.0 g/m² to 8.0 g/m², and the dry adhesive article exhibits a peel adhesion within a range of from 1.06 N/cm to 1.55 N/cm and a dynamic shear force within a range of from 46.0 N/cm² to 58.0 N/cm².

8. The dry adhesive article of claim 1, wherein the layer of nanofibers has a coat weight within a range of from 1.2 g/m² to 12.8 g/m², and the dry adhesive article exhibits a peel adhesion within a range of from 0.39 N/cm to 1.36 N/cm and a dynamic shear force within a range of from 28.1 N/cm² to 54.5 cm².

9. A method of forming a layer of nanofibers comprising:
applying a voltage to a liquid composition comprising a polyacrylate block copolymer dissolved in one or more solvents;
projecting the liquid composition toward a collector, with at least a portion of the one or more solvents evaporating before reaching the collector; and
depositing nanofibers comprising the polyacrylate block copolymer onto the collector, thus forming a layer of nanofibers on the collector, wherein the nanofibers are randomly oriented on the collector.

10. The method of claim 9, wherein
the one or more solvents comprise both methyl ethyl ketone and N,N-dimethylacetamide, and
cent ages of methyl ethyl ketone and N,N-dimethylacetamide both exceed 20 wt %, and the weight percentage of N,N-dimethylacetamide exceeds the weight percentage of methyl ethyl ketone.

11. (canceled)

12. The method of claim 9, wherein
the one or more solvents are chosen from the group consisting of: tert-butyl acetate; N,N dimethylacetamide; methyl ethyl ketone; n-butyl acetate, iso-butyl acetate; methyl isobutyl ketone; and ethyl acetate.

13-15. (canceled)

16. The method of claim 9, wherein
the polyacrylate block copolymer comprises at least an A polymer block and a B polymer block, where the A polymer block has a softening point above room temperature, and the B polymer block has a softening point below room temperature.

17. The method of claim 16, wherein
the A polymer block is poly(methyl methacrylate).

18. The method of claim 9, wherein
the polyacrylate block copolymer is arranged A-B-A, where A is poly(methyl methacrylate) and B is poly(n-butyl acrylate).

19. The method of claim 18, wherein
a weight percentage of poly(methyl methacrylate) in the polyacrylate block copolymer is 10 wt % to 25 wt %.

20. The method of claim 9, wherein the liquid composition further comprises:
a tackifier dissolved in the one or more solvents.

21. (canceled)

22. The method of claim 9, wherein the liquid composition further comprises:
a salt,
wherein the salt comprises pyridinium formate.

23-24. (canceled)

25. The method of claim 9, wherein
the liquid composition comprises: from 20 wt % to 40 wt % of the polyacrylate block copolymer and from 50 wt % to 70 wt % of the one or more solvents.

26. The method of claim 25, wherein the liquid composition further comprises 5 wt % to 15 wt % of a tackifier.

27. The method of claim 9, wherein the one or more solvents are substantially free of a solvent with a chlorine moiety.

28-46. (canceled)
